(19) United States
(12) Patent Application Publication
(10) Pub. No.: US 2008/0199361 A1
(43) Pub. Date: Aug. 21, 2008

(54) Hand-held pipetting device

(76) Inventors: Francis Gomes, Lincoln Park, NJ (US); Bruce Feller, Wayne, NJ (US); David Landsberger, Caldwell, NJ (US); Paul Thom, Butler, NJ (US)

Correspondence Address: SILBER & FRIDMAN, 1037 ROUTE 46 EAST, SUITE 207, CLIFTON, NJ, 07013, US

(21) Appl. No.: 11/707,821

(22) Filed: Feb. 16, 2007

(51) Int. Cl. B01L 3/02

(52) U.S. Cl. 422/100

(57) ABSTRACT

A hand-held pipetting device for drawing liquid into and dispensing liquid from a pipette includes head and handle portions that are rotatably connected together. One or more extender modules may be connected between the head and handle portions. The handle portion includes a normally biased trigger mechanism that crimps flexible aspirating and dispensing conduits. Pressure against the conduits may be released by squeezing the trigger mechanism so that one or more of the conduits is partially or fully opened. A pipette holder is rotatably and removably connected to the head portion. When the holder is rotated, the attached pipette can be positioned generally vertically or at an angle with respect to the pipetting device.

### BACKGROUND OF THE INVENTION

The present invention relates generally to liquid handling devices, and more particularly to a hand-held pipetting device for drawing liquid into and expelling liquid from a pipette.

It is known in the prior art to provide a pipetting device for drawing a precise volume of liquid from a supply. A typical pipetting device comprises a hand-held unit in communication with a laboratory pipette at one end and connected to either a remote or local air pressure source at the other end. A valve located within the pipetting device regulates the flow of air through the gun and to the pipette to control either the intake or expulsion of liquid through the pipette. The operator regulates air flow to the pipette by depressing either the positive pressure trigger or negative pressure trigger on the pipetting device. The magnitude of the pressure is predetermined and controlled by valve located within the pipette gun housing. Some prior art pipetting devices are provided with a universal nose piece attachment for cooperating and communicating with pipettes of various lengths and diameters. Since different pipette sizes often require different flow rates, some prior art pipetting devices are provided with complicated and costly valve mechanisms to adjust the liquid flow rate. In addition, the use of longer pipettes may require the user to place his or her hand or arm at an uncomfortable level.

In completely portable pipetting devices, the local air pressure source is typically provided by actuating a battery-operated peristaltic pump. Electrically operating devices differ somewhat from other types of prior art pipetting devices in that they typically cannot be calibrated. Accordingly, their accuracy is determined largely by the printed graduations on the disposable tubes and the user's ability to view the graduations. However, it is often difficult to directly view the graduations during filling due to the location of the tank relative to the user, whether the user is right- or left-handed, as well as other factors. The user's head and/or wrist must be turned in order to better view the graduations. Consequently, the tip of the pipette may be inadvertently lifted from the liquid and lead to inaccuracies in measurement, and other difficulties.

### BRIEF SUMMARY OF THE INVENTION

According to one aspect of the invention, a hand-held pipetting device for drawing liquid into and dispensing liquid from a pipette includes a head portion; a pipette holder connected to the head portion and for removably receiving a pipette; and a handle portion rotatably connected to the head portion for rotation about the longitudinal axis to thereby adjust a position of the pipette with respect to a user.

According to a further aspect of the invention, a hand-held pipetting device for drawing liquid into and dispensing liquid from a pipette comprises a head portion; a pipette holder connected to the head portion and adapted for removably receiving a pipette; at least one extender module connected to the head portion; and a handle portion connected to the head portion via the at least one extender module.

According to yet a further aspect of the invention, a hand-held pipetting device for drawing liquid into and dispensing liquid from a pipette comprises a head portion; a pipette holder connected to the head portion and adapted for removably receiving a pipette; a handle portion connected to the head portion; and a trigger mechanism operatively associated with the handle portion for selectively drawing liquid into and dispensing liquid from a pipette. The trigger mechanism comprises at least one flexible tubing in fluid communication with the pipette holder and at least one push-button movable between an extended position and a depressed position for selective engagement with the at least one flexible tubing to at least partially restrict an amount of fluid passing through the tubing.

According to another aspect of the invention, a hand-held pipetting device for aspirating liquid into and dispensing liquid from a pipette comprises a head portion; a handle portion connected to the head portion; and a pipette holder connected to the head portion and adapted for removably receiving a pipette. The pipette holder comprises a cap that includes a base section that is rotatably connected to the head portion and a conical section that extends from the base section such that the pipette is adapted to rotate as the cap is rotated with respect to the head portion.

### BRIEF DESCRIPTION OF THE DRAWINGS

The foregoing summary as well as the following detailed description of the preferred embodiments of the present invention will be best understood when considered in conjunction with the accompanying drawings, wherein like designations denote like elements throughout the drawings, and wherein:

FIG. 1 is a side elevational view of a pipetting device according to one embodiment of the invention showing a head portion connected to a handle portion in accordance with one aspect of the invention;

FIG. 2 is a side elevational view of the pipetting device of FIG. 1 with an extender module connected between the head and handle portions in accordance with another aspect of the invention;

FIG. 3 is a side elevational view of the pipetting device with a plurality of extender modules connected between the head and handle portions in accordance with yet another aspect of the invention;

FIG. 4 is a side elevational view of the extender module;

FIG. 5 is a top plan view of the extender module;

FIG. 6 is a bottom plan view of the extender module;

FIG. 7 is a sectional view of the extender module taken along line 7-7 of FIG. 4;

FIG. 8 is a sectional view of a portion of the extender module taken along line 8-8 of FIG. 5;

FIG. 9 is a sectional view of the extender module taken along section line 9-9 of FIG. 4;

FIG. 10 is a sectional view of the extender module taken along section line 10-10 of FIG. 4;

FIG. 11 is a side elevational view of the handle portion of the pipetting device;

FIG. 12 is a top plan view of the handle portion;

FIG. 13 is a side elevational view in partial cross section of the handle portion showing the trigger mechanism in a closed position;

FIG. 14 is a sectional view of the handle portion taken along section line 14-14 of FIG. 13;

FIG. 15 is a view similar to FIG. 13 showing the trigger mechanism in the open position;

FIG. 16 is a sectional view of the handle portion taken along section line 16-16 of FIG. 15;

FIG. 17 is a side elevational view in partial cross section of the head portion of the pipetting device showing details of the pipette holder;

FIG. 18 is a bottom plan view of the head portion as viewed from line 18-18 of FIG. 17;

FIG. 19 is a view similar to FIG. 17 showing the pipette holder in a rotated position;

FIG. 20 is a bottom plan view of the pipette holder taken along section line 20-20 of FIG. 17;

FIG. 21 is a sectional view of the pipette holder taken along section line 21-21 of FIG. 17;

FIG. 22 is a sectional view of a rotational element of the head portion taken along line 22-22 of FIG. 17;

FIG. 23 is a side elevational view of the pipetting device showing rotation of the nose assembly between first and second positions for adjusting the angular position of a pipette connected to the nose assembly;

FIG. 24 is a side elevational view of a portion of the pipetting device in partial cross section showing the pivot connection between the head and handle portions;

FIG. 25 is a side elevational view of a portion of the pipetting device in partial cross section showing the pivot connection between the head portion and the extender module;

FIG. 26 is a sectional view of the pivot connection taken along line 26-26 of FIGS. 24 and 25;

FIG. 27 is a bottom sectional view of the pipetting device taken along line 27-27 of FIGS. 24 and 25;

FIG. 28 is a view of the pipetting device similar to FIG. 27 with the handle portion or extender module rotated to a first position with respect to the head portion;

FIG. 29 is a view of the pipetting device similar to FIG. 27 with the handle portion or extender module rotated to a second position with respect to the head portion;

FIG. 30 is a side elevational view of a portion of the pipetting device in partial cross section showing the pivot connection between the head and handle portions in accordance with a further embodiment of the invention;

FIG. 31 is a side elevational view of a portion of the pipetting device in partial cross section showing a pivot connection between adjacent extender modules; and

FIG. 32 is a sectional view of the pivot connection taken along line 32-32 of FIGS. 30 and 31.

It is noted that the drawings are intended to depict only typical embodiments of the invention and therefore should not be considered as limiting the scope thereof. It is further noted that the drawings are not necessarily to scale. The invention will now be described in greater detail with reference to the accompanying drawings.

### DETAILED DESCRIPTION OF THE INVENTION

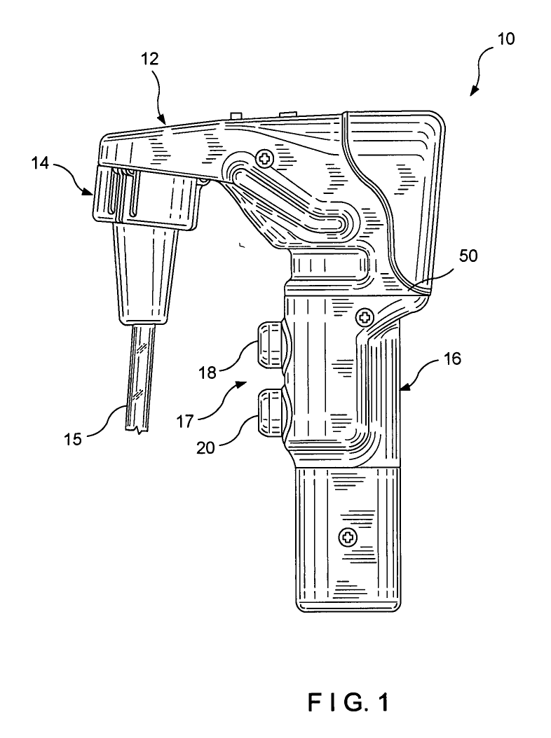

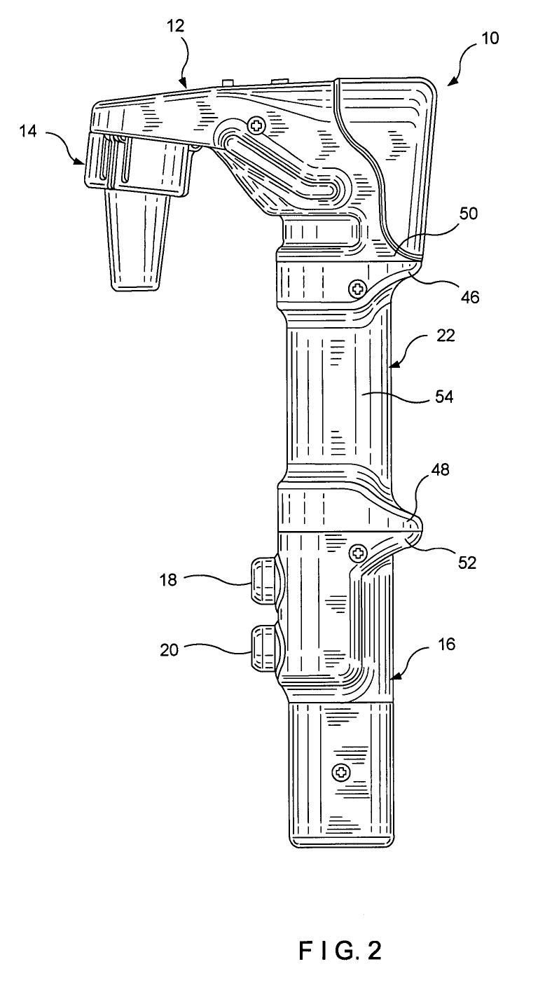

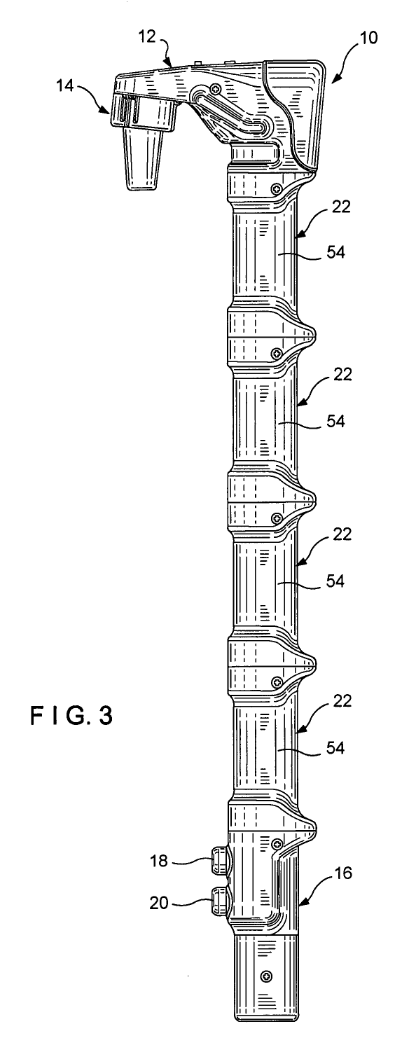

Referring to the drawings and to FIGS. 1-3 in particular, a pipetting device 10 in accordance with an exemplary embodiment of the present invention is illustrated. The pipetting device 10 preferably includes a head portion 12 with a pipette holder 14 for receiving a pipette 15 (FIG. 1), a handle portion 16 with a trigger mechanism 17 having a positive pressure trigger 18 for dispensing fluid from the pipette and a negative pressure trigger 20 for drawing fluid into the pipette 15, and an extender module 22 connected between the head and handle portions. As shown in FIG. 1, the handle portion 16 is directly connected to the head portion 12, while in FIG. 2, the handle portion is connected to the head portion through a single extender module 22 that extends between the head and handle portions. In FIG. 3, a plurality of extender modules 22 are connected between the head and handle portions.

The provision of one or more extender modules 22 is particularly advantageous in that it allows the handle portion 16 to be held at a comfortable level during pipetting operations, where the pipette may be of different lengths or where the liquid holding tank or liquid level within the tank may be at different heights. In the case where space limitations are a factor, the extender module(s) may be removed, as in the FIG. 1 embodiment, to provide a shorter pipetting device.

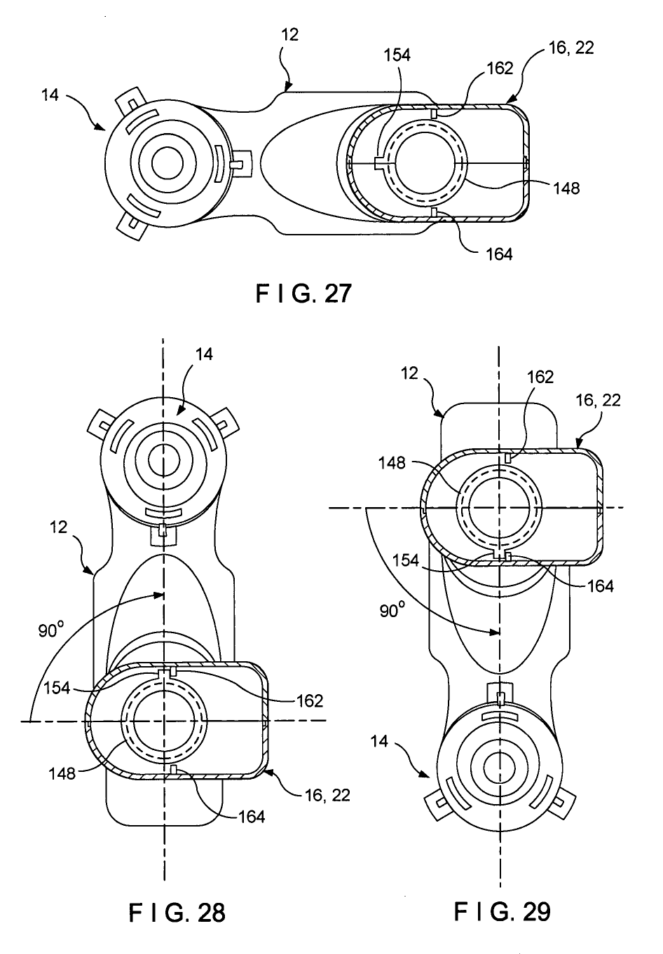

Preferably, the head portion 12 is rotatable with respect to the handle portion 16 at a first pivot joint, as will be described in greater detail below, so that the user can move or swivel the head portion 12, and thus the attached pipette 15, with respect to the handle portion 16 (see FIGS. 28-29). Where one or more extender modules are used, the head portion and handle portion are preferably independently rotatable with respect to the extender module at first and second pivot joints. Preferably, the head portion 12 and handle portion 16 are mutually rotatable in both a clockwise and counter-clockwise direction from the neutral position (FIG. 27) over a range of about 90 degrees to the positions shown in FIGS. 28 and 29. However, it will be understood that the head and handle portions may rotate through any desired angle, including 180 degrees or 360 degrees. The extender modules 22 are preferably fixedly connected together against relative rotation, so that only the head and handle portions are allowed to swivel or rotate. However, it will be understood that the extender modules 22 may alternatively be rotatably connected together, as shown for example in FIGS. 31 and 32. It will be further understood that only the head portion 12 or the handle portion 16 may rotate with respect to one or more of the extender modules 22.

The swivel or rotational arrangement of the head and handle portions of the pipetting device 10 of the present invention offers several advantages over prior art pipetting devices having fixed head and handle portions. For example, the operator of the pipetting device according to the present invention is able to move or swivel the head portion 12 with respect to the handle portion 16 to a position where the graduated scale on the pipette 15 and the relative position of liquid in the pipette can be better viewed without the need to twist the user's wrist or head to observe the readings. In addition, the swivel arrangement facilitates use of the pipetting device 10 by both right and left hand operators, especially since rotational movement of the head portion 12 and/or handle portion 16 through 90 degrees from the neutral position in either the clockwise or counterclockwise position is possible.

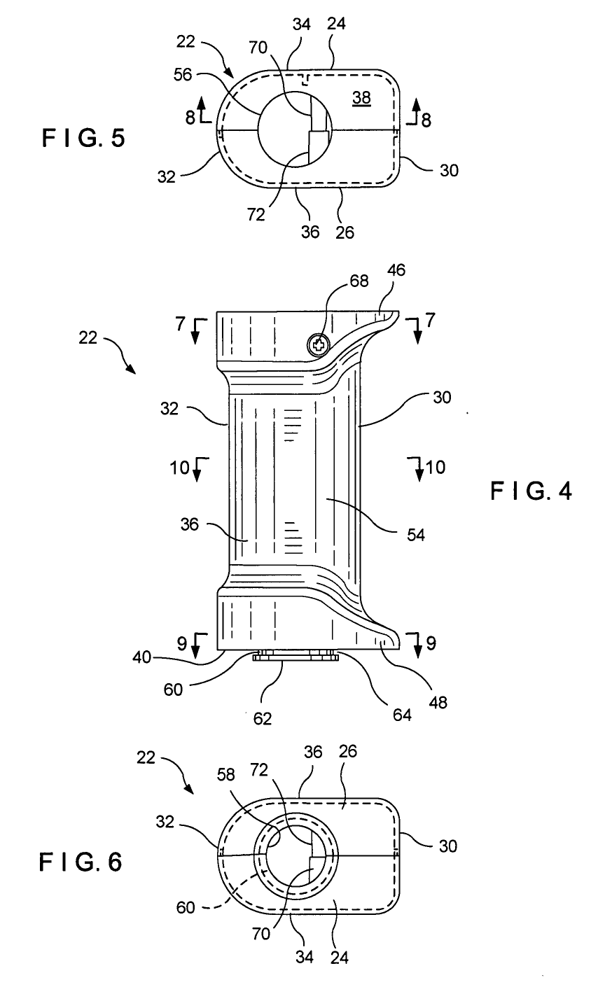

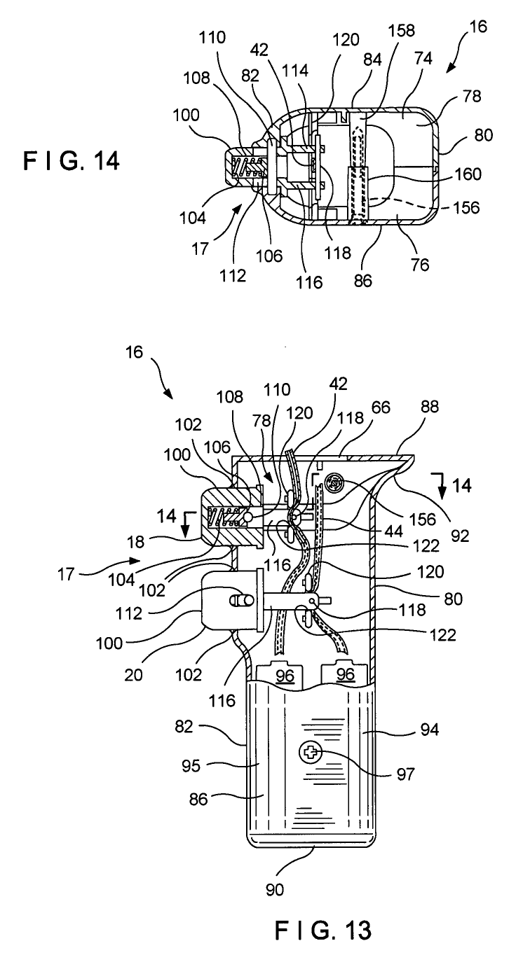

Referring now to FIGS. 4-10, the extender module 22 preferably includes extender housing segments 24, 26 connected together to form a rear wall 30, a curved front wall 32, side walls 34, 36 extending between the rear and front walls, a top wall 38 and a bottom wall 40 extending between the front, rear and side walls. The top wall 38 and bottom wall 40 together with the front wall 32, rear wall 30 and side walls 34, 36 form a hollow interior 28 through which electrical wires (not shown) and tubing 42, 44 (FIG. 13) may extend for operating the pipetting device 10, as will be described in further detail below.

The top wall 38 and bottom wall 40 preferably have a profile that matches the profile of a lower end 50 of the head portion 12 and an upper end 52 of the handle portion 16. To that end, an upper enlarged section 46 is formed at the upper end of the extender module 22 and a lower enlarged section 48 is formed at the lower end of the extender module. When the extender module 22 is installed between the head portion 12 and handle portion 16, the upper projection 46 and lower projection 48 ensure a smooth and aesthetically pleasing transition between the head portion and extender module and between the extender module and handle portion, as shown in FIG. 2. When two or more extender modules are used, a smooth and aesthetically pleasing transition is also ensured between adjacent extender modules, as shown in FIG. 3. In addition, the narrow section 54 (FIGS. 2-4) formed between the enlarged sections 46, 48 provides an additional area that can be grasped or clamped during operation of the pipetting device 10. Consequently, both the narrow section 54 and the handle portion 16 can be simultaneously grasped to provide greater stability of the pipetting device 10 during pipetting operations.

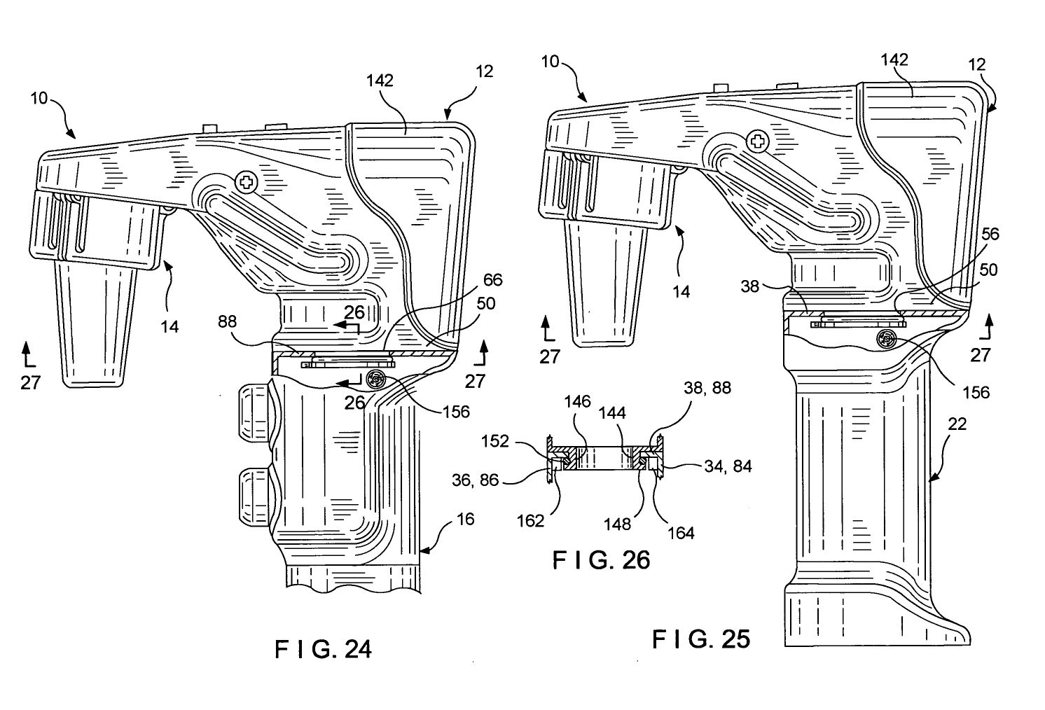

Referring to FIGS. 4-9, an upper opening 56 is formed in the top wall 38 and a lower opening 58 is formed in the bottom wall 40 of the extender module 22. An annular wall 60 extends downwardly from the bottom wall 40 and surrounds the lower opening 58. An annular flange 62 is formed at the lower end of the annular wall 60 and extends radially therefrom to form an annular gap 64. Preferably, the outer diameter of the annular wall 60 is equal to or slightly smaller than the diameter of the upper opening 56 so that the extender module 22 may be connected to an adjacent extender module 22 or handle portion 16 by locating the annular gap 64 in the opening 56 of an adjacent module 22 or in the upper opening 66 (FIGS. 12, 13) of an adjacent handle portion 16, as shown for example in FIGS. 24, 25, 30 and 31.

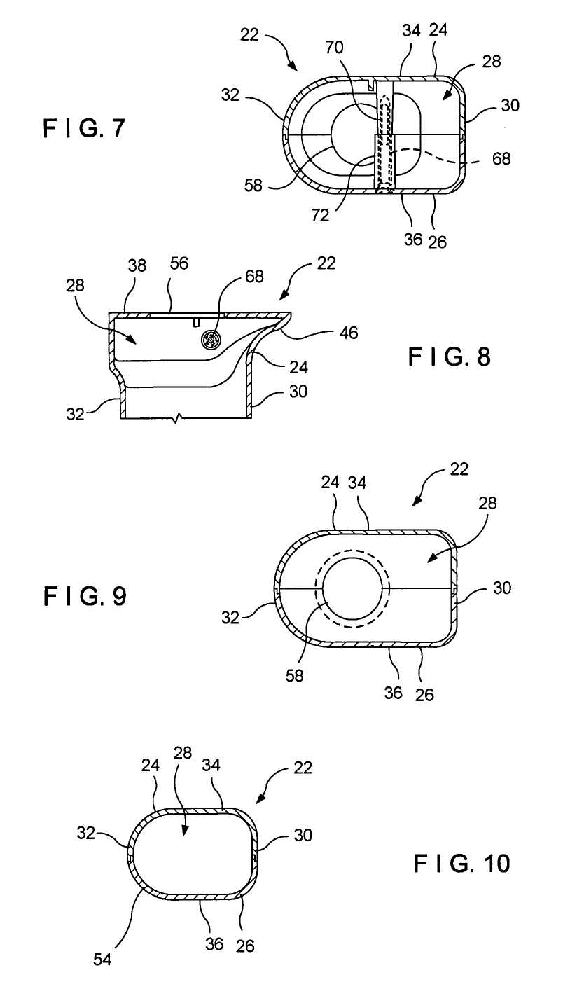

In order to attach two extender modules together, and with additional reference to FIG. 31, the housing segments 24, 26 of a first extender module are preferably separated and the annular wall 60 of a second extender module is aligned with the upper opening 56 of the first extender module. The housing segments 24, 26 of the first extender module are then secured together by a fastener 68 (shown in dashed line in FIG. 7) that extends through opposing bosses 70 and 72 in the housing segments 24 and 26, respectively. It will be understood that other fastening means can be used to secure the housing segments together, such as adhesive bonding, welding, complementary locking elements, and so on.

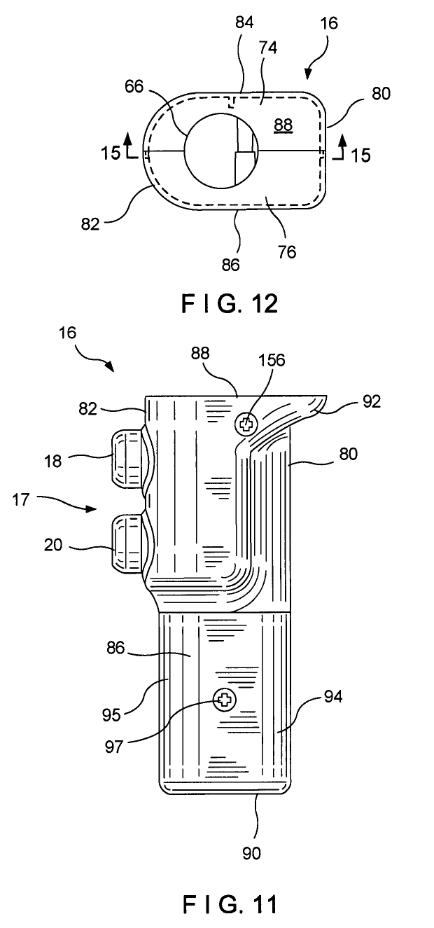

Referring now to FIGS. 11-16, the handle portion 16 includes handle housing segments 74, 76 connected together to form a rear wall 80, a curved front wall 82, side walls 84, 86 extending between the rear and front walls, a top wall 88 and a bottom wall 90 extending between the front, rear and side walls. The top wall 88 and bottom wall 90 together with the front wall 82, rear wall 80 and side walls 84, 86 form a hollow interior 78 into which electrical wires (not shown), the tubing 42, 44 and the trigger mechanism 17 extend for operating the pipetting device 10.

An enlarged section 92 is formed at the upper end of the handle portion 16 so that the top wall 88 has a profile that matches the profile of the lower end 50 (FIG. 1) of the head portion 12 and the bottom wall 40 (FIG. 6) of the of the extender module 22 so that the handle portion 16 can be connected directly to either the head portion 12 or the extender module 22. The trigger mechanism 17 is preferably incorporated into the enlarged section 92. A narrow section 94 is formed below the enlarged section 92 and is preferably of a size and shape to receive batteries 96 for providing electrical power to the head portion 12 of the pipetting device 10. To that end, the narrow section 94 of the side wall 86 includes a removable battery cover 95 for replacing the batteries as needed. The battery cover may be held in position by a screw 97 or other fastener that engages a boss (not shown) in the opposite side wall 84. It will be understood that the battery cover may be secured by other well known fastening means or may be eliminated when a recharging connector is provided on the handle portion 16. It will be further understood that electrical power may be provided to the pipetting device 10 through other well known means.

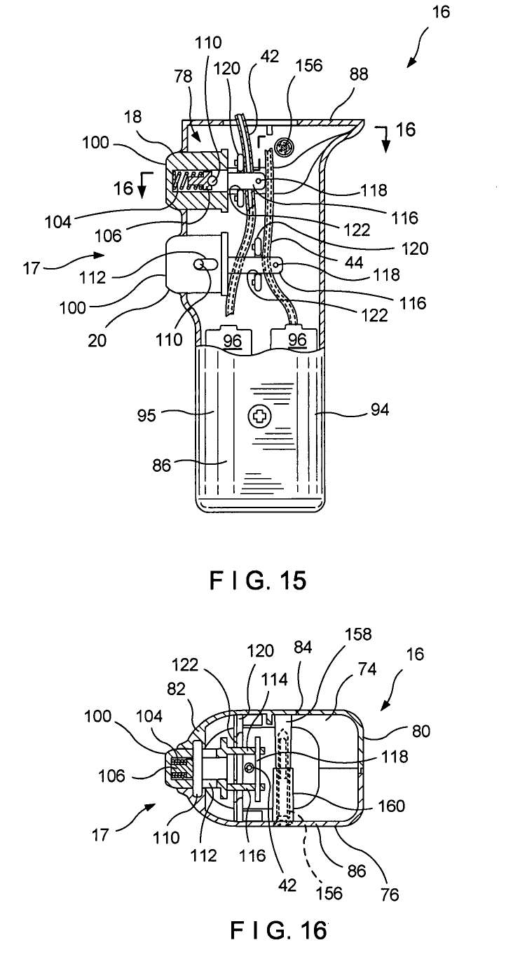

As best shown in FIGS. 13-16, the trigger mechanism 17 includes a positive pressure trigger 18 for dispensing fluid from the pipette and a negative pressure trigger 20 for drawing or aspirating fluid into the pipette 15, as previously described. Each trigger 18, 20 preferably includes a push-button 100 that slides through an opening 102 formed in the front wall 82 of the handle portion 16. A compression spring 104 and plunger 106 are located within a bore 108 of each push-button 100. A rod 110 is fixedly secured to the front wall 82 and extends through a slot 112 (FIG. 14) that intersects with the bore 108. The rod 110 rides along the slot 112 and serves to hold the plunger 106 and spring 104 in place during movement of the push-button 100 against spring bias between the normally extended position (FIG. 13) and the depressed position (FIG. 15). A pair of arms 114, 116 (FIGS. 14, 16) extend rearwardly from the push-button 100 on either side of the bore 108. A pin 118 extends between the arms 114, 116 and is securely connected thereto.

A partition 120 extends between the side walls 84 and 86 of the handle portion 16. Each partition includes a passage 122 for receiving the arms 114, 116. Due to the combination of the arms 114, 116 riding in the passage 122 and the rod 110 riding in the slot 112, the push-button 100 is guided in a linear direction between the extended and depressed positions. When in the normally extended position, as shown in FIG. 13, the pin 118 and partition 120 function as crimping members for crimping or pinching the tubing 42, 44 so that the flow of fluid within the tubing can be controlled. Preferably, the lower partition 120 is offset from the upper partition 120 to avoid possible interference between the tubing and the pressure trigger components.

In use, the tubing 42, 44 are preferably connected to a leg of a peristaltic pump (not shown) or the like that is preferably mounted in the head portion 12. When it is desired to draw liquid into the pipette 15 from a tank or the like, the push-button 20 is depressed against bias from the spring 104 to push the pin 118 away from the tubing 42 and uncrimp the tubing. When it is desired to expel liquid from the pipette 15, the push-button 20 is released and the push-button 18 is depressed against bias from the spring 104 to push the pin 118 away from the tubing 44 and uncrimp the tubing. The crimping feature may not only be used for totally opening or closing the interior of the tubing, but also to control the amount of opening or closing and therefore the amount of fluid flow through the tubing. Accordingly, the push-button 100 can be moved to any intermediate position between the fully extended and fully depressed positions. This feature is particularly advantageous since it provides a great amount of control over fluid flow while eliminating the expense associated with more sophisticated valving arrangements of the prior art.

Depending on the particular design of the peristaltic pump, the trigger mechanism 17 may be used to dispense liquid from the pipette 15 under gravity without actuating the pump. This may be accomplished by designing the rotors of the peristaltic pump so that they do not completely close the flexible peristaltic linkage.

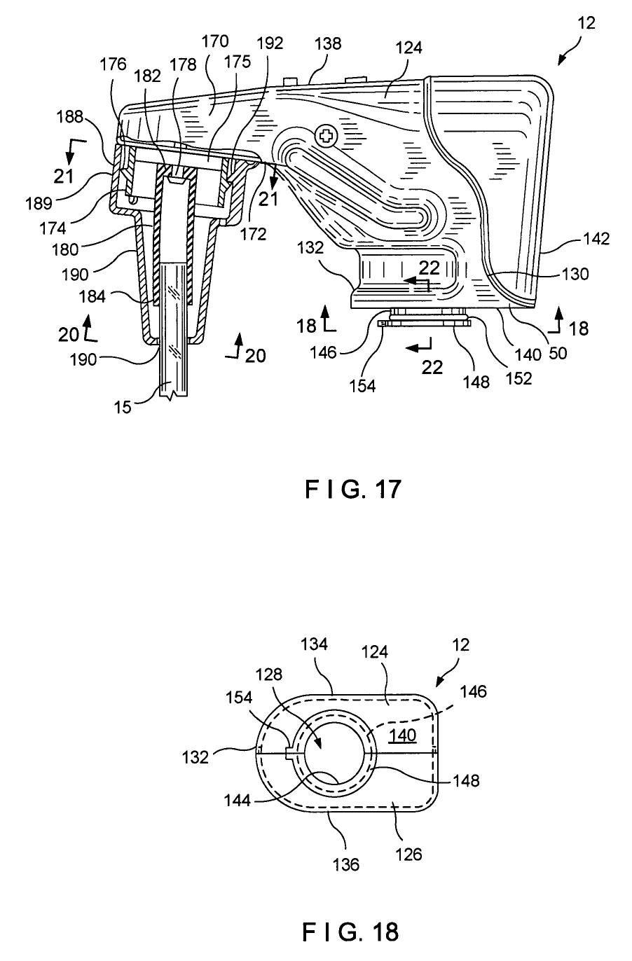

Referring now to FIGS. 17-26, the head portion 12 includes head housing segments 124, 126 connected together to form a rear wall 130, a curved front wall 132, side walls 134, 136 extending between the rear and front walls, a top wall 138 and a bottom wall 140 extending between the front, rear and side walls. The top wall 138 and bottom wall 140 together with the front wall 132, rear wall 130 and side walls 134, 136 form a hollow interior 128 (FIG. 18) into which electrical wires (not shown), the tubing 42, 44, peristaltic pump (not shown) and electrical circuit (not shown) are positioned for operating the pipetting device 10. A rear cover 142 is connected to the rear wall 130 and houses an electrical motor (not shown) for operating the peristaltic pump. The electrical motor may be connected by wires (not shown) to the batteries 96 (FIG. 13) or other power source for operating the pump. The electrical circuit, motor and pump are well-known components and therefore will not be further described.

The bottom wall 140 of the head portion 12 has a profile that matches the profile of the top wall 88 of the handle portion 16 (FIGS. 12 and 24) and the top wall 38 of the extender module 22 (FIGS. 5 and 25) so that the head portion 12 can be connected directly to either the handle portion 16 or the extender module 22.

As shown most clearly in FIGS. 17-19 and 22, a rear opening 144 is formed in the bottom wall 140. An annular wall 146 extends downwardly from the bottom wall 140 and surrounds the rear opening 144. An annular flange 148 is formed at the lower end of the annular wall 146 and extends radially therefrom to form an annular gap 150. An O-ring 152 is positioned in the gap 150, preferably adjacent the flange 148 and surrounds the annular wall 146. A stop tab 154 extends radially from the flange 148. Preferably, the outer diameter of the annular wall 146 is equal to or slightly smaller than the diameter of an upper opening 66 or 56 so that the head portion 12 may be connected to an adjacent handle portion 16 (FIGS. 1 and 24) or extender module 22 (FIGS. 2 and 25) by locating the annular wall 146 and thus the annular gap 150 in the opening 66 of an adjacent handle portion 16 or in the opening 56 of an adjacent module 22.

In order to rotatably attach the housing portion 12 to the handle portion 16 the housing segments 74, 76 of the handle portion are preferably separated and the annular wall 146 of the head portion 12 is aligned with the upper opening 66 of the handle portion, with the O-ring 152 located between the annular flange 148 and the top wall 88 of the handle portion, as shown in FIGS. 24-26. The housing segments 74, 76 are then secured together by a fastener 156 (shown in dashed line in FIGS. 14 and 16) that extends through opposing bosses 158 and 160 in the housing segments 74 and 76, respectively, of the handle portion 16. It will be understood that other fastening means can be used to secure the housing segments together, such as adhesive bonding, welding, complementary locking elements, and so on. Rotatable attachment of the head portion to the extender module 22 is accomplished in a similar manner and therefore will not be further described. The O-ring 152 ensures smooth, controlled rotational movement between the head portion and the handle portion or extender module 22.

Referring now to FIGS. 26-29, 31 and 32, when it is desirous to limit rotation of the head portion 12 with respect to the handle portion 16 and/or the extender module 22, a pair of stops 162, 164 are provided in the housing segments on opposite sides of the upper opening 56 or 66. As the head portion 12 is rotated in a clockwise direction from the neutral position as viewed in FIG. 27 to the position shown in FIG. 28, the tab 154 extending from the flange 148 engages the stop 162 to thereby prevent further clockwise movement beyond 90 degrees from the FIG. 27 position. Likewise, as the head portion 12 is rotated in a counter-clockwise direction to the position shown in FIG. 28, the flange 148 engages the stop 164 to thereby prevent further counter-clockwise movement beyond 90 degrees from the FIG. 27 position, giving a total of 180 degrees of rotation. It will be understood that the stops may be located at any position in proximity to the opening 56 or 66 in order to provide a greater or lesser range of rotational movement. For example, the stops may be arranged so that the head portion rotates over a range of plus and minus 180 degrees. It will be further understood that a single stop may be positioned on the housing portion and/or extender module and a pair of tabs may be positioned on the head portion to obtain the same range of rotational movement.

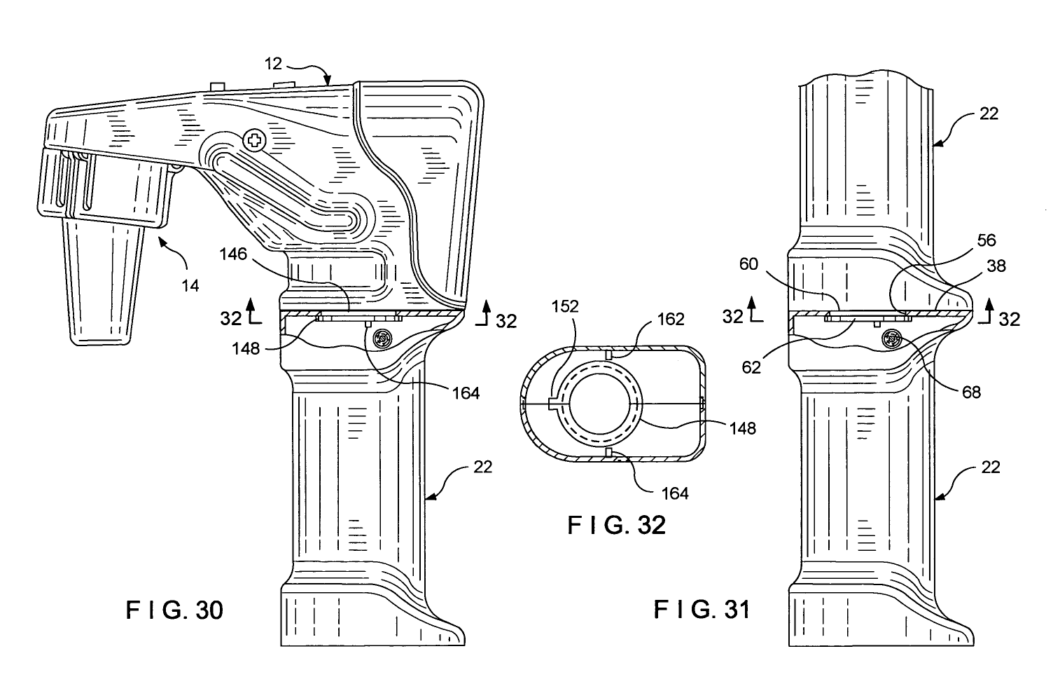

As shown in FIGS. 30 and 32, and in accordance with a further embodiment of the invention, the O-ring 152 may be eliminated, and the annular wall 146 of the head portion 12 may be shortened so that an upper surface of the annular flange 148 frictionally engages a lower surface of the upper wall 38 of the extender module 22.

Referring now to FIGS. 17-21, the head portion 12 also includes a cantilevered nose section 170 with a lower wall 172 that extends at an acute angle, preferably between about 7.5 and 15 degrees with respect to the bottom wall 140 or horizontal when the head portion 12 is held upright. It will be understood that this angle may greatly vary.

The pipette holder 14 extends from the bottom wall 140 and includes an annular wall 174 that extends generally downwardly and forwardly from the lower wall 172, preferably at an angle between about 7.5 and 15 degrees with respect to the longitudinal axis of the handle portion 16 and/or extender module 22 when attached, or from vertical when the pipetting device is held upright. The annular wall 174 includes an outwardly projecting annular ledge 176. A conduit 178 extends through the lower wall 172, preferably concentrically with the annular wall 174, and is in fluid communication with a filter 175, such as a hydrophobic filter, in the head portion 12 and the tubing 44, 46. The filter 175 is of well-known construction and operation and therefore will not be further described. A flexible tube 180 has an upper end 182 mounted to the conduit 178 and a lower end 184 that is sized to receive and frictionally hold an upper end of the pipette 15 so that the pipette is also in fluid communication with the tubing 44, 46 when inserted into the tube 180.

A cap 186 is removably connected to the annular wall 174 and includes a hollow base section 188 and a hollow conical section 190 extending from the base section. Preferably, the conical section 190 extends at an angle between about 7.5 and 15 degrees with respect to a central axis of the base section 188. However, it will be understood that the particular angle of the conical section 190 with respect to the base section 188 may be selected from a wide range of angles. The conical section 190 includes an opening 196 through which the pipette 15 extends when connected to the flexible tube 180.

The base section 188 includes an annular wall 189 with a plurality of inwardly projecting resilient catches 192 that engage the annular ledge 176 in a snapping action for holding the cap 186 onto the cantilevered nose section 170. This snapping feature allows a simple and efficient way of rotatably connecting the cap 186 to the nose section 170 without the use of threads as in prior art solutions. A tab 194 is preferably aligned with each catch 192 and extends outwardly from the annular wall 189. One or more of the tabs can be manipulated by a user to release one or more catches from the annular ledge and remove the cap 186 from the nose section 170. The ability to quickly replace the pipette holder 14 is thus greatly simplified over prior art solutions. Accordingly, when the pipetting device 10 is sold or distributed, it can be accompanied by a wide variety of different pipette holders for accommodating specific applications. Although three flexible catches and their accompanying tabs are shown, it will be understood that more or less tabs and/or catches can be used. It will be further understood that the tabs may be eliminated and/or that other means for rotatably locking the cap onto the annular wall 174 may be used.

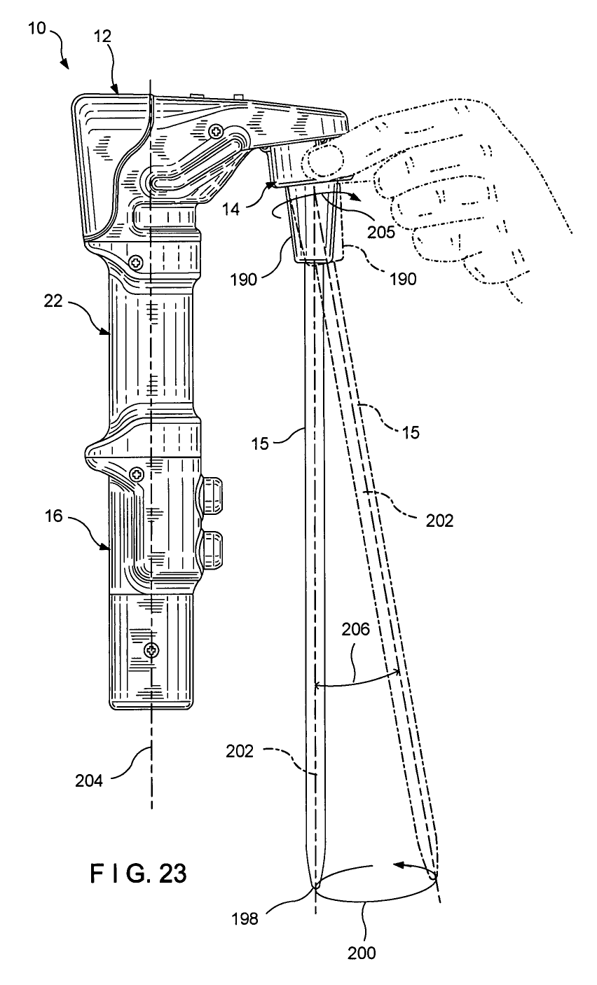

In use, and referring to FIGS. 17, 19 and 23, the combination of the annular ledge 176 on the annular wall 174 and the catches 192 on the base section 188 permit the cap 186 to rotate through 360 degrees about the annular wall 174, as represented by arrow 205 in FIG. 23, without causing the pipette holder 14 to become loose or separated as in prior art solutions. Preferably, the cap 186 stays in the adjusted position during pipetting operations. This can be accomplished by frictional engagement of the catches with the annular ledge, interlocking elements (not shown) on the head portion and cap, or by any other locking means.

Due to the angular orientation of the lower wall 172 of the cantilevered nose section 170 and the angular relationship between the base section 188 and conical section 190, the conical section will follow a circular or elliptical path through the 360 degree rotation of the cap 186, which in turn guides movement of the lower tip 198 of the pipette 15 along a larger elliptical path 200 without rotation of the pipette about its longitudinal axis 202.

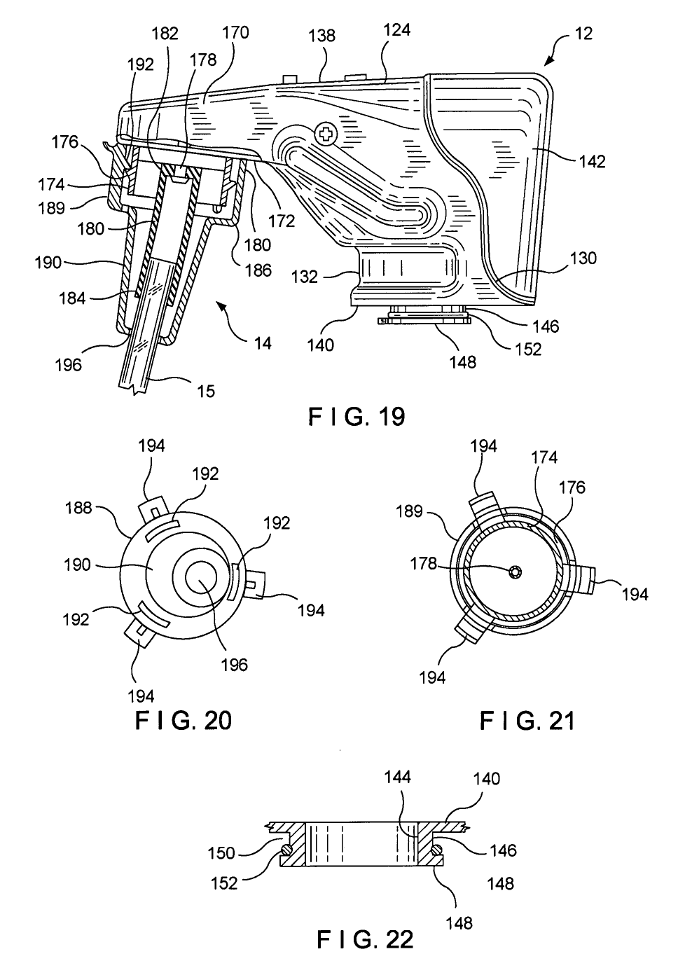

When the angle of the lower wall 172 and the angle between the base section 188 and conical section 190 are substantially the same, rotation of the cap until the angles are opposing, and thus canceling each other out, will result in the conical section, and thus a longitudinal axis 202 of the pipette 15, to be oriented substantially parallel to a longitudinal axis 204 of the pipetting device 10, as shown in FIGS. 17 and 23. When the cap 186 is rotated approximately 180 degrees, the longitudinal axis 202 of the pipetting device 15 will extend at an angle 206 with respect to the longitudinal axis 204, as shown in FIGS. 19 and 23. The value of the angle 206 is the sum of the angle of the lower wall 172 and the angle between the base and conical sections. By way of example when the lower surface is angled at 7.5 degrees and the conical section is angled at 7.5 degrees with respect to the base section, the total angle 204 of the pipetting device with respect to the axis 204 will be approximately 15 degrees. The flexibility of the tube 180 ensures that the pipette 15 can freely move along the elliptical path 200.

It will be understood that the term “preferably” as used throughout the specification refers to one or more exemplary embodiments of the invention and therefore is not to be interpreted in any limiting sense. It will be further understood that the term “connect” and its various derivatives as may be used throughout the specification refer to components that may be joined together either directly or through one or more intermediate members. In addition, terms of orientation and/or position as may be used throughout the specification relate to relative rather than absolute orientations and/or positions.

It will be appreciated by those skilled in the art that changes could be made to the embodiments described above without departing from the broad inventive concept thereof. It will be understood, therefore, that this invention is not limited to the particular embodiments disclosed, but is intended to cover modifications within the spirit and scope of the present invention as defined by the appended claims.

We claim:

1. A hand-held pipetting device for drawing liquid into and dispensing liquid from a pipette, the pipetting device having a longitudinal axis and comprising:
a head portion;
a pipette holder connected to the head portion and adapted for removably receiving a pipette; and
a handle portion rotatably connected to the head portion for rotation about the longitudinal axis to thereby adjust a position of the pipette with respect to a user.

2. A pipetting device according to claim 1, and further comprising a first extender module connected between the head portion and the handle portion, at least one of the head and handle portions being rotatably connected to the extender module about the longitudinal axis.

3. A pipetting device according to claim 2, wherein the head portion and handle portion are rotatably connected to the extender module.

4. A pipetting device according to claim 2, and further comprising a second extender module connected between the first extender module and the handle portion, the first and second extender modules being at least substantially identical in construction.

5. A pipetting device according to claim 4, wherein the first and second extender modules are fixedly connected together.

6. A pipetting device according to claim 4, wherein the first and second extender modules are rotatably connected together about the longitudinal axis.

7. A pipetting device according to claim 2, wherein the handle portion comprises a trigger mechanism for selectively drawing liquid into and dispensing liquid from a pipette, the trigger mechanism comprising:
at least one flexible tubing in fluid communication with the pipette holder; and
at least one push-button movable between an extended position and a depressed position for selective engagement with the at least one flexible tubing to thereby at least partially restrict an amount of fluid passing through the tubing.

8. A pipetting device according to claim 7, wherein the at least one push-button is biased toward the extended position to completely crimp the flexible tubing and is movable toward the depressed position to partially or completely release the tubing from the crimped condition.

9. A pipetting device according to claim 2, wherein the handle portion comprises a trigger mechanism for selectively drawing liquid into and dispensing liquid from a pipette, the trigger mechanism comprising:
first and second flexible tubing in fluid communication with the pipette holder for drawing fluid into and dispensing liquid from the pipette, respectively;
a first push-button movable between an extended position and a depressed position for selective engagement with the first flexible tubing to thereby at least partially restrict an amount of fluid passing through the first flexible tubing; and
a second push-button movable between an extended position and a depressed position for selective engagement with the second flexible tubing to thereby at least partially restrict an amount of fluid passing through the second flexible tubing.

10. A pipetting device according to claim 9, wherein each push-button is biased toward the extended position to completely crimp its associated flexible tubing and is movable toward the depressed position to partially or completely release its associated tubing from the crimped condition.

11. A pipetting device according to claim 9, wherein the pipette holder is rotatable with respect to the head portion to thereby adjust a rotational position of the pipette.

12. A pipetting device according to claim 11, wherein the pipette holder comprises a cap including a base section rotatably connected to the head portion at a first angle with respect to the longitudinal axis and a conical section extending from the base section at a second angle with respect to a central axis of the base section such that the pipette describes a circle or ellipse as the cap is rotated with respect to the head portion.

13. A pipetting device according to claim 12, and further comprising a flexible tube located within the cap for receiving the pipette.

14. A hand-held pipetting device for drawing liquid into and dispensing liquid from a pipette, the pipetting device comprising:
a head portion;
a pipette holder connected to the head portion and adapted for removably receiving a pipette;
at least one extender module connected to the head portion; and
a handle portion connected to the head portion via the at least one extender module.

15. A pipetting device according to claim 14, wherein the at least one extender module comprises a plurality of extender modules, each extender module being at least substantially identical in construction.

16. A pipetting device according to claim 15, wherein the plurality of extender modules are fixedly connected together.

17. A pipetting device according to claim 15, wherein at least two of the extender modules are rotatably connected together about the longitudinal axis.

18. A pipetting device according to claim 14, wherein at least one of the head portion and handle portion is rotatably connected to the extender module for rotation about a longitudinal axis of the pipetting device to thereby adjust an angular position of the pipette.

19. A hand-held pipetting device for drawing liquid into and dispensing liquid from a pipette, the pipetting device comprising:
a head portion;
a pipette holder connected to the head portion and adapted for removably receiving a pipette;
a handle portion connected to the head portion; and
a trigger mechanism operatively associated with the handle portion for selectively drawing liquid into and dispensing liquid from a pipette, the trigger mechanism comprising:
at least one flexible tubing in fluid communication with the pipette holder; and
at least one push-button movable between an extended position and a depressed position for selective engagement with the at least one flexible tubing to thereby at least partially restrict an amount of fluid passing through the tubing.

20. A pipetting device according to claim 19, wherein the at least one push-button is biased toward the extended position to completely crimp the flexible tubing and is movable toward the depressed position to partially or completely release the tubing from the crimped condition.

21. A hand-held pipetting device for aspirating liquid into and dispensing liquid from a pipette, the pipetting device comprising:
a head portion;
a handle portion connected to the head portion; and
a pipette holder connected to the head portion and adapted for removably receiving a pipette, the pipette holder comprising a cap including a base section rotatably connected to the head portion and a conical section extending from the base section such that the pipette is adapted to rotate as the cap is rotated with respect to the head portion.

22. A pipetting device according to claim 21, wherein the conical section extends at a first angle with respect to a central axis of the base section.

23. A pipetting device according to claim 22, wherein the central axis of the base section extends at a second angle with respect to the head portion.

24. A pipetting device according to claim 22, wherein the first and second angles are substantially equal such that a longitudinal axis of the pipette extends at least substantially parallel to a longitudinal axis of the pipetting device when the cap is in a first position and extends at an angle to the longitudinal axis of the pipetting device when the cap is rotated to a second position.

25. A pipetting device according to claim 21, wherein the head portion includes an annular wall and an annular ledge that extends outwardly from the annular wall, and further wherein the cap includes a plurality of resilient catches for engaging the annular ledge to thereby rotatably and removably connect the cap to the head portion.

26. A pipetting device according to claim 21, and further comprising a flexible tube located within the cap for receiving the pipette.
